(19) United States
(12) Patent Application Publication
(10) Pub. No.: US 2013/0124849 A1
(43) Pub. Date: May 16, 2013

(54) System And Method For Individualizing Content For A Consumer

(71) Applicants: Joseph D. Steele, Danville, CA (US); James L. Lester, Dublin, CA (US)

(72) Inventors: Joseph D. Steele, Danville, CA (US); James L. Lester, Dublin, CA (US)

(21) Appl. No.: 12/548,126

(22) Filed: Aug. 26, 2009

(51) Int. Cl. H04L 9/28; H04L 9/00

(52) U.S. Cl. 713/150; 380/28

(57) ABSTRACT

Protected content that has been encrypted according to an encryption algorithm is individualized for a consumer according to pseudorandomly-generated individualization data values and individualization indexes. When different instances of individualized protected content are generated from the same protected content for different consumers, the different instances differ in content. To generate the individualized protected content, a packaging component is configured to identify pseudorandom intervals within the protected content using the individualization indexes, and for each given one of the intervals, to combine the protected content included within the given interval with a respective one of the individualization values according to a reversible data transform operation. The data transform operation is less computationally expensive than the given encryption algorithm.

### BACKGROUND

1. Field of the Invention

The present invention is directed to computer systems. More particularly, it is directed to digital rights management within a computing environment.

2. Description of the Related Art

In prior years it would not be uncommon for an individual to obtain content (e.g., literary works, periodicals, music, and movies) from a retail location in the form of a physical medium. For example, an individual might travel to a local bookstore and purchase written works in the form of a book, newspaper, or magazine. In another example, an individual might purchase music stored on a Compact Disc (CD) or a motion picture stored on a Digital Video Disc (DVD). In recent years the ubiquity of the Internet and the World Wide Web has paved the way for alternative methods of obtaining content. For example, a user might log on to a music retailer's website and download a digital version of a music album. In other example, a user might log on to a movie subscription provider's website to download or stream a motion picture to view on a personal computer. In the case of books, a user might log on to a bookseller's website and download an electronic book (“e-book”) for view on a computer system, such as a desktop computer or a handheld e-book reader.

The Internet and World Wide Web serve as a backbone for numerous file sharing mechanisms. Examples of such mechanisms include electronic mail (“email”) and more advanced file distribution software, such as peer-to-peer (“P2P”) file sharing applications. In many cases, such file sharing mechanisms are often utilized to distribute electronic content to individuals that are not authorized to access such content. Such distribution is likely due in part to the relative ease and anonymity of sharing files through such mechanisms. To combat unauthorized consumption of content, some content owners have adopted an approach to protecting their content known as digital rights management (“DRM”), which may include various techniques for limiting access of electronic content to authorized individuals.

### SUMMARY

Various embodiments of a system and method for individualizing content for consumers are described. In some embodiments, a system may include a memory and processor(s) coupled to the memory, where the memory stores program instructions executable by the processor(s) to implement a packaging component. The packaging component may be configured to receive a request to package protected content for a given consumer according to pseudorandomly-generated individualization data values ID(k) and pseudorandomly-generated individualization indexes IX(k), where the protected content is encrypted according to a given encryption algorithm. The packaging component may also be configured to generate individualized protected content that has been individualized for the given consumer, such that when different instances of individualized protected content are generated from a same version of the protected content for different consumers, the different instances differ in content.

To generate the individualized protected content, the packaging component may be configured to identify pseudorandom intervals within the protected content using the individualization indexes, and for each given one of the intervals, to combine the protected content included within the given interval with a respective one of the individualization values according to a reversible data transform operation. The data transform operation may be less computationally expensive than the given encryption algorithm.

In some embodiments, a system may include a memory and processor(s) coupled to the memory, where the memory stores program instructions executable by the processor(s) to implement a digital rights management (DRM) component that corresponds to a given consumer. The DRM component may be configured to receive protected content that has been individualized for the given consumer according to pseudorandomly-generated individualization data values ID(k) and pseudorandomly-generated individualization indexes IX(k), wherein the protected content is encrypted according to a given encryption algorithm. The individualized protected content may be individualized for the given consumer such that when different instances of individualized protected content are generated from a same version of the protected content for different consumers, the different instances differ in content.

The DRM component may be further configured to recover the protected content from the individualized protected content. To recover the protected content, the DRM component may be configured to identify pseudorandom intervals within the protected content using the individualization indexes, and for each given one of the intervals, to combine the individualized protected content included within the given interval with a respective one of the individualization values according to an inverse of a reversible data transform operation used to generate the individualized protected content. The data transform operation and its inverse may be less computationally expensive than the given encryption algorithm.

### BRIEF DESCRIPTION OF THE DRAWINGS

FIG. 1 illustrates a data flow diagram of the packaging, distribution and acquisition of content, according to various embodiments.

FIG. 2 illustrates a possible vulnerability of non-individualized protected content to a differential attack.

FIGS. 3A-C are block diagrams illustrating various embodiments of a system configured to perform content individualization for consumers.

FIG. 4 is a flow diagram illustrating a method of delivering individualized content to a consumer, according to various embodiments.

FIG. 5 is a flow diagram illustrating a method of operation of a license server to implement a content individualization process, according to various embodiments.

FIG. 6 is a flow diagram illustrating a method of operation of a packaging server to implement a content individualization process, according to various embodiments.

FIG. 7 is a flow diagram illustrating a method of operation of a client system to process individualized content, according to various embodiments.

FIG. 8 is a flow diagram illustrating a process by which an individualization key may be regenerated from individualized protected data, according to various embodiments.

FIG. 9 graphically illustrates differences between two example versions of individualized protected content that may be generated from the same input content.

FIG. 10 illustrates an example computer system suitable for implementing various components discussed herein, according to various embodiments.

While the disclosure is set forth herein by way of example for several embodiments and illustrative drawings, those skilled in the art will recognize that the disclosure is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the disclosure as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. In various portions of the description presented herein, the terms “validate”, “verify”, “validation”, “verification”, “validating”, and “verifying” may be used interchangeably.

### DETAILED DESCRIPTION OF EMBODIMENTS

### Introduction

Various embodiments of a system and method for individualizing content for consumers are described. Following the preliminary remarks in this section, a general overview of digital rights management is provided, followed by an overview of the different entities that may play roles in distributing content within a DRM content distribution system. Embodiments of techniques for content individualization are then introduced and discussed from the operational perspectives of a license server, a packaging server, and a client system corresponding to a consumer. Finally, an example embodiment of a computer system that may be employed to implement these techniques is described.

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follows are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Note that the description presented herein may include one or more references to a one-way function or a cryptographic hash function, either of which may be referred to herein as simply a hash function. In various embodiments, the hash functions described herein may be any of various hash functions including, but not limited to, the Secure Hash Algorithm (SHA) (e.g., SHA-1, SHA-0, SHA-224, SHA-256, SHA-384, SHA-512, and other SHA variations), the RACE Integrity Primitives Evaluation Message Digest (RIPEMD) (e.g., RIPEMD-128, RIPMED-160, RIPEMD-256, RIPEMD-320, and other RIPEMD variations), the Message Digest algorithm (MD) (e.g., MD-3, MD-4, MD-5, and other MD variations), the Tiger and Tiger2 hash functions (e.g., Tiger-128, Tiger-160, Tiger-192, Tiger2-128, Tiger2-160, Tiger2-192, and other Tiger variations), the Very Efficient Substitution Transposition (VEST) (e.g., VEST-4, VEST-8, VEST-16, VEST-32, and other VEST variations), the WHIRLPOOL hash function, some other hash function whether presently known or developed in the future, and/or some combination or variation of any of the aforesaid hash functions.

Various embodiments include various encryption and/or decryption keys, any of which may be generated via a key derivation function (KDF). Key derivation functions may include one or more iterations or instances of hash functions and/or other cryptographic operations in order to generate an encryption or decryption key. Examples of key derivation function may include but are not limited to any key derivation functions specified by Public Key Cryptography Standards (PKCS) (e.g., PKCS-5) or Adobe Password Security. In various embodiments, KDFs may be utilized by any of the various components described herein to generate keys for symmetric encryption.

Various portions of this detailed description may refer to “client(s)” and “server(s).” For instance, various embodiments may include (among other elements) a client system (or simply a “client”), an individualization server, and/or a license server. It should be understood that the terms “client” and “server” do not impose any limitation on the operation, configuration, or implementation of such elements. It should be understood that these terms are used only as convenient nomenclature. Indeed, various embodiments are in no way limited by the principles of a conventional client-server architecture. For instance, any of the “clients” or “servers” described herein may be configured to communicate according to a variety of communication protocols or system architectures, such as a peer-to-peer (P2P) architecture or some other architecture, whether such architecture is presently known or developed in the future.

In various instances, this detailed description may refer to content (which may also be referred to as “content data,” “content information” or simply “data” or “information”). In general, content may include any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to Adobe® Flash® Video (.FLV) format or some other video file format whether such format is presently known or developed in the future.

In various embodiments, content may include electronic representations of music, spoken words, or other audio, which may include but is not limited to data files adhering to the MPEG-1 Audio Layer 3 (.MP3) format, Adobe® Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, Adobe® Photoshop® (.PSD) format or some other format for electronically storing text, graphics and/or other information whether such format is presently known or developed in the future. In some embodiments, content may include any combination of the above-described examples.

In various instances, this detailed disclosure may refer to consuming content or to the consumption of content, which may also be referred to as “accessing” content, “viewing” content, “listening” to content, or “playing” content, among other things. In some cases, the particular term utilized may be dependent on the context in which it is used. For example, consuming video may also be referred to as viewing or playing the video. In another example, consuming audio may also be referred to as listening to or playing the audio.

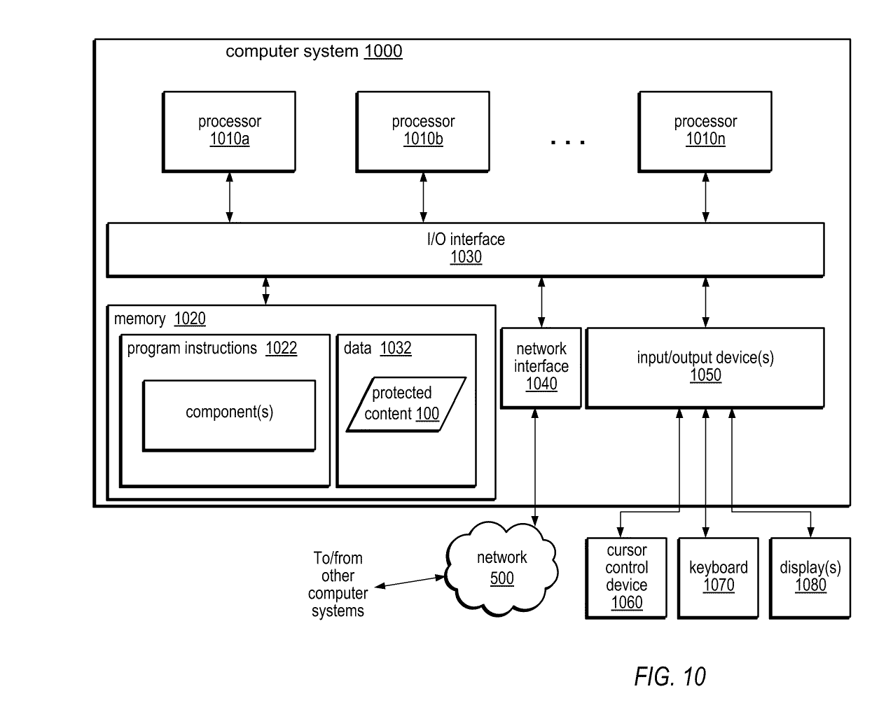

In various instances, this detailed description may refer to a device on which content may be consumed. In various embodiments, such a device may include but is not limited to a computing system (e.g., a desktop or laptop computer), a digital audio or multimedia player (e.g., an MP3 player), a personal digital assistant (PDA), a mobile phone, a smartphone, an e-book reader, a digital photo frame, or any other device or system configured to access, view, read, write, and/or manipulate any of the content data described herein. Any of such devices may be implemented via a computer system similar to that described with respect to FIG. 10.

Note that in various instances the description presented herein may refer to a given entity performing some action. It should be understood that this language may in some cases mean that a system (e.g., a computer system) owned and/or controlled by the given entity is actually performing the action. Moreover, in various instances, this detailed description may refer to data that is generated “randomly” or “at random.” It is noted that in various embodiments, such data need not be purely random, but may be generated according to any suitable pseudorandom technique or procedure. Thus, in at least some embodiments, random data includes pseudorandom data. Similarly, where data is described as being “pseudorandom,” in at least some embodiments, such data may include data that is purely random.

### Digital Rights Management System Overview

Various embodiments of the system and method for individualizing content for a consumer may include a digital rights management (DRM) framework configured to provide access to protected content (e.g., content that is encrypted and/or subject to usage rights) in response to the successful completion of a DRM process. As described in more detail below, such a DRM verification process may include the coordinated efforts of multiple systems including a system on which the consumption of content is attempted (e.g., a client system), a license server system configured to provide content licenses enabling the consumption of protected content, and a packaging/delivery server system configured to actually deliver the protected content to the client. (As noted below, in some embodiments, the functionality of the license server and the packaging/delivery server may be integrated into a single server.) The client system may in various embodiments include a DRM component (e.g., on a client computer system) configured to carry out DRM operations (e.g., decrypting content and/or enforcing usage rules) such that the content can be consumed (e.g., viewed, played, etc.). One particular example of a DRM component includes Adobe® DRM Client for Flash® Player, though other examples are possible and contemplated.

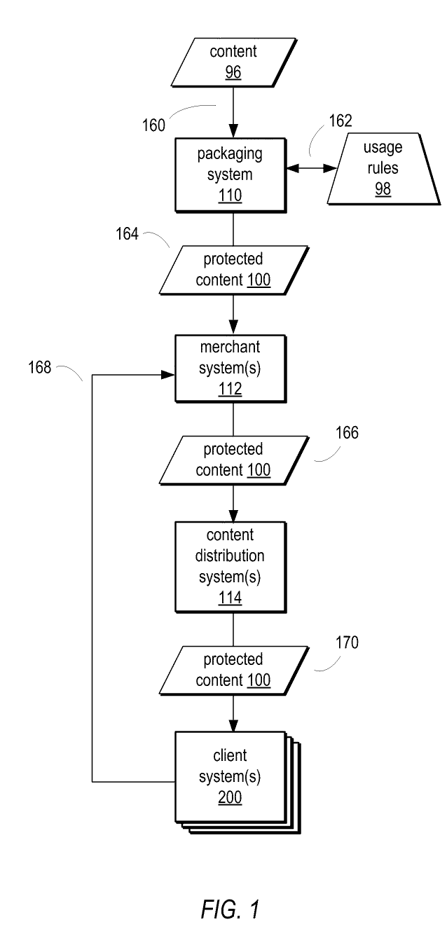

The client system may obtain encrypted content from a variety of sources (e.g., as described with respect to FIG. 1 below). To obtain the content license for that content, the DRM component may be configured to submit a license request to a license server. The license request may in various embodiments include machine credentials that have been individualized with respect to the client system. For example, machine credentials may be generated based on the specific configuration of hardware and/or software present at the client system, such that different client systems are likely to produce different machine credentials, thus reducing the likelihood that content authorized for one client system will be misappropriated for use with a different client system. In some embodiments, the license request may include a digital certificate (from the machine credentials) that includes an identifier of the client system and a corresponding public key. In various embodiments, the certificate may be digitally signed by a trusted third party (which may be, e.g., a certificate authority or an individualization server). In various embodiments, the digital signature may indicate that the signing party attests to the validity of the information within the certificate. The license request may include other information (e.g., a username or other user identifier, a content identifier of the content for which a license is requested, etc.) as described in more detail below.

When a license request is received, the license server may be configured to perform one or more verifications on which the issuance of a content license is dependent. For instance, the license server may ensure that the client system is not on a machine revocation list (e.g., a list that identifies machines known to be security threats or otherwise unsuitable for receiving a content license) and that the user is authorized to access the content. In response to performing the appropriate verifications, the license server may issue the content license to the client system. In various embodiments, the license server may bind the content license to the client machine. For example, the license server may access a public key from a digital certificate provided by the client system in the license request. In some embodiments, this digital certificate may be the digital certificate from the machine credentials issued to the client system as mentioned above. The license server may in various embodiments encrypt the content license with this public key. In this way, only a system that holds the corresponding private key (e.g., the client system) may be able to decrypt the content license. In some embodiments, this private key may be the private key from the machine credentials issued to the client system by an individualization server.

Subsequent to receiving the encrypted content license, the DRM component on the client system may decrypt the content license with a private key, which in some embodiments may be obtained from the machine credentials. In various embodiments, the DRM component may access the content license and usage rules (if any) from the content license and decrypt the corresponding content. If usage rules are present, the DRM component may enforce restrictions set forth by those rules (e.g., enforcing a rental period for the content).

### Overview of Content Packaging Distribution and Acquisition in a DRM System

FIG. 1 illustrates a data flow diagram representing the packaging, distribution, and acquisition of protected content according to various embodiments. Content 96 may represent any of the content described above (e.g., videos, music, documents, etc.). Prior to being prepared for delivery to a client, content 96 may be stored in a “clear” or unencrypted state. The process of preparing content 96 for delivery as protected content 100 may be referred to generically as “packaging.”

As shown in FIG. 1, at item 160 of the data flow diagram, content 96 may be provided to packaging system 110. For instance, a content owner may provide content 160 to an entity controlling packaging system 110, such as an entity that provides packaging and encoding services for digital content. Packaging system 110 may also be configured to receive (or generate) usage rules, such as usage rules 98 (see e.g., item 162 of the data flow diagram). Usage rules 98 may include any restrictions on the use, access, or consumption of the content, including, but not limited to, restricting the access of content to a particular time period (e.g., a rental time period or some other time period), restricting the actions (e.g., view, copy, save, distribute, etc.) that can be performed with respect to the protected content, and/or some other restriction on the content (e.g., a restriction might ensure content be viewed with embedded advertising content). Note that various systems (e.g., a merchant system) might modify the usage rules at a later point in time. For instance, if a merchant sells a movie rental, the merchant may modify usage rules to specify a rental period for the movie.

Packaging system 110 may generate protected content 100 based from content 96 and usage rules 98. The generation of protected content 100 may in various embodiments include encrypting content 96. For instance, the content may be encrypted with a content encryption key via a symmetric encryption process. (Note that this content encryption key may in some cases be the key that is included in a content license for the content, which is described in more detail below.) In some cases, to generate protected content 100, packaging system 110 may be configured to encode content 96 according to various codecs (e.g., video compression codecs, an example of which includes video codecs utilized to generate Adobe® Flash® Video files).

As illustrated at item 164 of the data flow diagram, packaging system 110 may be configured to provide protected content 100 to one or more merchant system(s) 112. In one example, merchant system(s) 112 may include one or more computer systems for implementing an electronic commerce (“e-commerce”) portal. One example of an e-commerce portal includes an e-commerce website that offers content (and possibly other items) as the basis for a commercial transaction (e.g., sale, rent, trade, auction, etc.). While in some embodiments merchant system(s) 112 may be configured to provide protected content 100 directly to client systems 200 via one or more data networks, in the illustrated embodiment merchant system 112 may provide protected content 100 to one or more intermediate systems (as illustrated by item 166 of the data flow diagram). In the illustrated example, such an intermediate system might include content distribution system(s) 114, which may include a content distribution network (CDN). In various embodiments, such CDN may be optimized for the high-speed transfer of data including multi-media content and/or other types of content.

As illustrated at item 168 of the data flow diagram, one or more client system(s) 200 may submit a request for content. This request can include a variety of information including but not limited to user information, such as authentication information (e.g., a username and password or some other authentication information for identifying a user or customer). The request may include but is not limited to transaction-related information, such as payment information (e.g., credit card numbers, bank account numbers, billing addresses, etc.). The request may include but is not limited to information for identifying the content requested, such as a content identifier or other information for identifying the particular content requested.

Merchant system 112 may accept or reject the request shown as item 168 (e.g., based on the information included in the request). If the request is rejected, client system 200 may not be provided with access to the requested content. If the request is accepted, client system 200 may be allowed to receive the protected content 100 as illustrated at item 170. For instance, a client system 200 may download protected content 100 from content distribution system(s) 114 via the Internet and/or other data networks. Client system(s) 200 may store any acquired protected content in local memory. Note that in addition to the content itself, client system 200 may in some cases need the corresponding content license to consume the content (e.g., the unprotected or unencrypted version of the content). For instance, the content license may include the correct encryption key for decrypting the protected content.

Note that in some embodiments, client system(s) 200 may acquire protected content according to techniques different than those described above. For instance, various ones of client(s) 200 may obtain protected content from sources other than content distribution system(s) 114. For example, one or more of client systems 200 operating in a P2P environment may distribute encrypted content according to one or more P2P protocols.

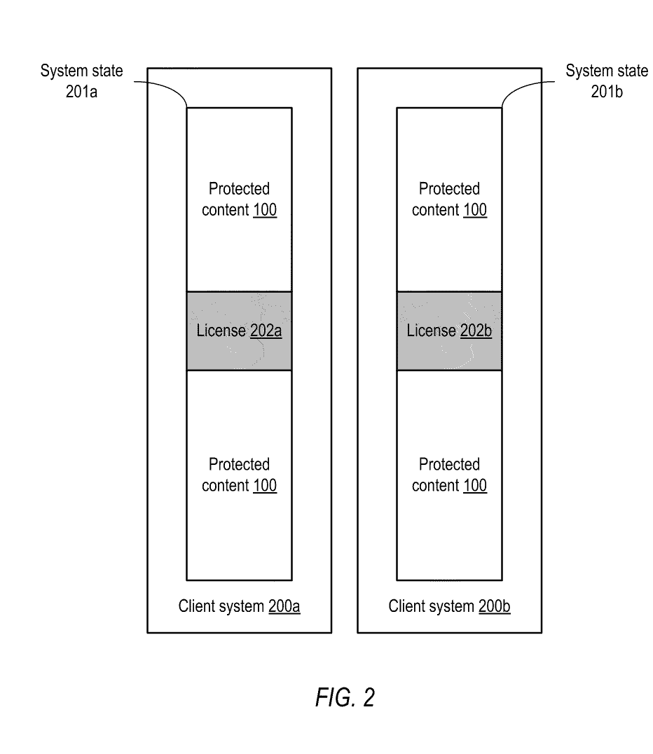

In particular, it is noted that the illustrated configuration of packaging system 110, merchant system 112, and content distribution system 114 is only one of many possible system architectures for delivering protected content. In other embodiments, the same system or group of systems may be configured to perform both packaging and delivery of content. Moreover, in some embodiments, content packaging and delivery may be performed on behalf of a merchant without protected content 100 ever passing directly through merchant system 112. For example, as discussed below with respect to FIG. 2, client system 200 might be configured to interact with a license server to obtain a license and with a packaging server to obtain content, without necessarily interacting with a merchant with respect to these tasks.

Also, it is noted that in addition to obtaining protected content, client system 200 may in various embodiments be configured to obtain the DRM component that facilitates the use of the protected content. For instance, in some embodiments, client system 200 may obtain bootstrapping logic (e.g., via content distribution systems 114 or from some other source). The client system 200 may be configured to execute the bootstrapping logic to obtain (e.g., download) the DRM component at runtime.

### Content Individualization

The protected content data flow shown in FIG. 1 illustrates a possible vulnerability that may exist in DRM content distribution systems. As noted above, one common task in the generation of protected content 100 is the encryption of content 96 through the use of encryption keys. Because encryption algorithms are computationally expensive, it may be infeasible or undesirable to uniquely encrypt content 96 each time it is requested by a client system 200, as this may unacceptably delay the delivery of protected content 100. Moreover, it may undesirable to encrypt and store different versions of content 96 according to different keys prior to requests by a client system 200, because the increased storage needed to store the redundant encrypted versions may increase the cost of maintaining and delivering content.

Encryption delay and storage requirements may be reduced, in some embodiments, by encrypting content 96 once according to a single encryption key and storing the result. The resulting protected content 100 may then be delivered to any requesting client system 200 on demand without encryption delay. However, if the encryption key is compromised and becomes disseminated, any user may be able to decrypt protected content 100 without obtaining (and paying for) a license to use the content.

To some extent, this risk may be ameliorated by including the encryption key within the license that is returned to client system 200, and encrypting the license itself according to a different key that is specific to a particular client or transaction. (Because the contents of the license are typically much smaller than the content itself, the computational overhead of encrypting each license for each client or transaction is typically much less than if the content were to be separately encrypted for different clients.) In such embodiments, the security of protected content 100 depends upon the security of the encrypted license.

Although using an encrypted license may improve the security of protected content 100, it may still be vulnerable to a concerted attack, as demonstrated by FIG. 2. FIG. 2 illustrates two different client systems 200a-b that have requested and obtained the same protected content 100. In the illustrated embodiment, protected content 100 is illustrated as being stored within the respective system state 201a-b of client systems 200a-b. For example, system state 201a-b may include system memory or disk storage in which protected content 100 may reside after having been obtained, e.g., from a content distribution system. Additionally, system state 201a is shown storing license 202a, which may include the encryption key for protected content 100 and which may have been specifically encrypted for client system 200a. Similarly, system state 201b stores license 202b, which may include the same encryption key as license 202a, but which may have been specifically encrypted for client system 200b in a manner distinct from license 202a (e.g., according to a different key). (For simplicity of illustration, protected content 100 and licenses 202a-b are shown in FIG. 2 as being contiguously stored within system state 201a-b. In other instances, these elements may be stored discontiguously.)

Generally speaking, a reversible encryption algorithm may produce identical output when identical input is encrypted using an identical key. Similarly, when identical input is encrypted using different keys, the encrypted output will generally differ. Thus, in the case of FIG. 2, if protected content 100 denotes the same original content encrypted according to the same key, protected content 100 should appear as the same sequence of information (e.g., sequence of bits or bytes) within both system state 201a and 201b. By contrast, licenses 202a-b, having been encrypted according to different keys (and possibly being different in their original content), should appear as distinct sequences of information within system states 201a-b.

Because licenses 202a-b, as stored within system state 201a-b, may represent differences in state within a large body of otherwise identical state (i.e., the state corresponding to protected content 100), a malicious party seeking to attack the encrypted licenses 202a-b may be able to readily extract the licenses from system state 201a-b by performing a differential analysis on client systems 200a-b. For example, the attacker may download the same protected content 100 to client systems 200a-b and compare system states 201a-b, disregarding the areas where system state is identical and selecting the areas where system state differs as potential areas of license data. Although an attacker would still need to compromise the encryption of licenses 202a-b in order to obtain the key used to encrypt protected content 100, this differential technique may enable the attacker to rapidly narrow the scope of the attack, and thus increase the risk that the content encryption will be compromised.

As noted above, encrypting content 96 with different keys would yield different versions of protected content 100, which would eliminate any easily identifiable correlation between the state of client systems 200a-b when each has a different version of protected content 100. In turn, this would frustrate the differential attack described above, in that it would no longer be possible to identify licenses 202a-b simply by scanning system state 201a-b for similarities and differences. However, as previously noted, performing multiple full encryption operations on content 96 may be computationally expensive.

However, as described in greater detail below, it may be possible to generate versions of protected content 100 that have been individualized for particular client systems 200, while using operations that are computationally less expensive than the encryption used to generate protected content 100 itself. As a result, it may be possible to efficiently generate individualized versions of protected content 100 that may be effective to thwart attacks based on content correlation, without incurring the overhead of full encryption. This process may be generally referred to herein as content individualization.

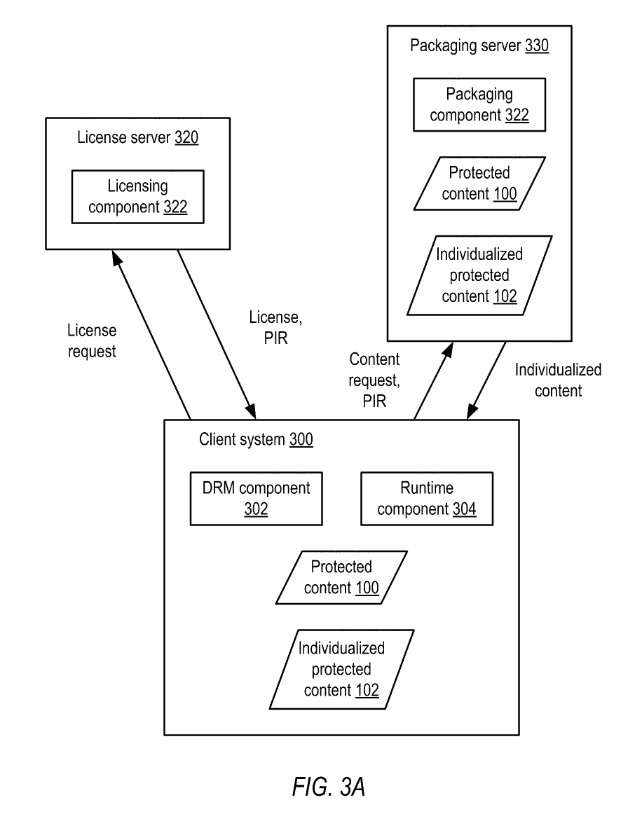

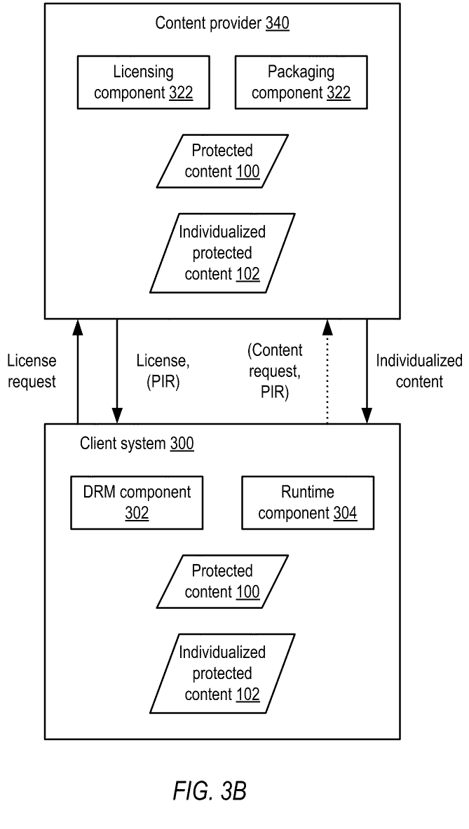

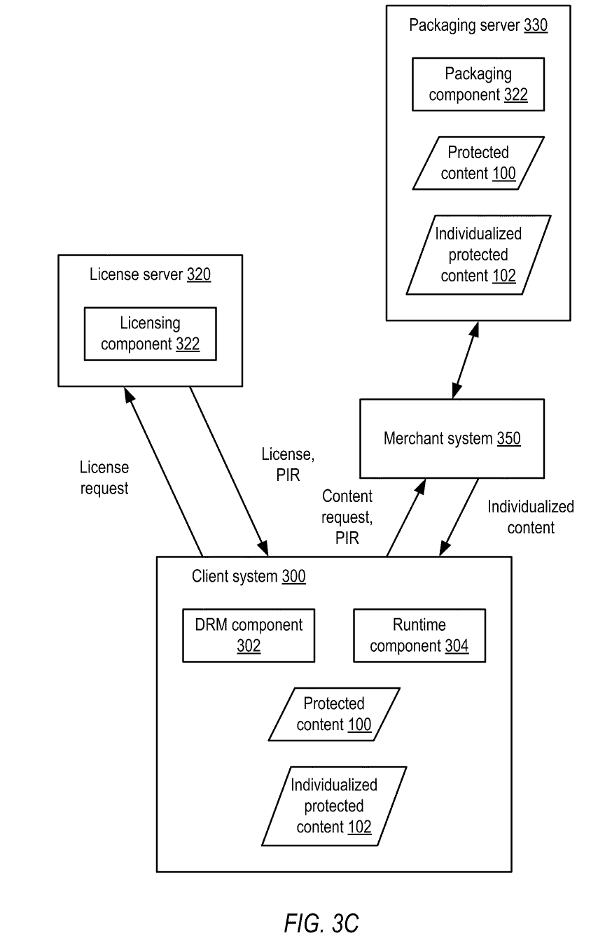

An example embodiment of a system configured to perform content individualization for consumers is illustrated in FIG. 3A. Prior to discussing the operation of the system, its organization is first described. In the illustrated embodiment, the system of FIG. 3A includes a client system (CS) 300, a license server (LS) 320, and a packaging/individualization server (PS) 330. CS 300 includes a DRM component 302 and a runtime component 304. LS 320 includes a licensing component 322, and PS 330 includes a packaging component 332.

Generally speaking, CS 300 may represent a system corresponding to a consumer of content. For example, CS 300 may be a computer system of the type described below with respect to FIG. 10. In various embodiments, DRM component 302 may be configured to carry out DRM operations (e.g., decrypting content and/or enforcing usage rules) such that the protected content 100 can be consumed (e.g., viewed, played, etc.) by a consumer using CS 300. In various embodiments, content that has been received and processed by DRM component 302 may be processed for presentation to a consumer (e.g., displayed, played, etc.) by runtime component 304. For example, runtime component 304 may include support for video and/or audio codecs or other functionality that may be useful in decoding or otherwise processing content for presentation to a consumer. In one particular example, runtime component 304 may be Adobe® Flash® Player or Adobe® AIR®. In various embodiments, DRM component 302 and runtime component 304 may be implemented via dedicated hardware within CS 300 (e.g., as implemented by semiconductor circuitry), via program instructions stored on a storage medium included in CS 300 and executable by a processor of CS 300 to implement the functionality of these components, or via a combination of these.

LS 320 may generally represent a system configured to manage the DRM credentials that may be necessary to enable a consumer to consume protected content 100. For example, LS 320 may be a computer system of the type described below with respect to FIG. 10. In various embodiments, licensing component 322 may be configured to manage license requests from consumers, to evaluate consumers' authority to receive requested protected content 100, and to issue DRM credentials (e.g., a “license” as discussed below) to authorized consumers in order to enable those consumers to obtain and decrypt protected content 100. In various embodiments, licensing component 322 may be implemented via dedicated hardware within LS 320 (e.g., as implemented by semiconductor circuitry), via program instructions stored on a storage medium included in LS 320 and executable by a processor of LS 320 to implement the functionality of these components, or via a combination of these.

PS 330 may generally represent a system configured to prepare and deliver protected content 100 to a consumer. For example, PS 330 may be a computer system of the type described below with respect to FIG. 10. In various embodiments, packaging component 332 may be configured to perform the content individualization discussed below, as well as to perform other operations related to the management and delivery of protected content 100. For example, packaging component 332 may be configured to encrypt content 96 according to an encryption key to generate protected content 100. In various embodiments, packaging component 332 may be implemented via dedicated hardware within PS 330 (e.g., as implemented by semiconductor circuitry), via program instructions stored on a storage medium included in PS 330 and executable by a processor of PS 330 to implement the functionality of these components, or via a combination of these.

It is noted that the system configuration of FIG. 3A is merely one example, and that numerous other configurations are possible and contemplated. For example, in the embodiment shown in FIG. 3B, the operations of LS 320 and PS 330 have been merged into a single content provider system 340 that includes both licensing component 322 and packaging component 332.

As another example, it is noted that neither LS 320 nor PS 330 need interact directly with CS 300. In the embodiment of FIG. 3C, a merchant system 350 has been interposed between CS 300 and LS 320 as well as PS 330. In such an embodiment, a consumer may interact with merchant system 350 to negotiate access to protected content 100, and merchant system 350 may interact with LS 320 and PS 330 to relay licensing information and/or packaged content on behalf of CS 300. In another embodiment, merchant system 350 may be interposed between CS 300 and one of LS 320 or PS 330, but not the other.

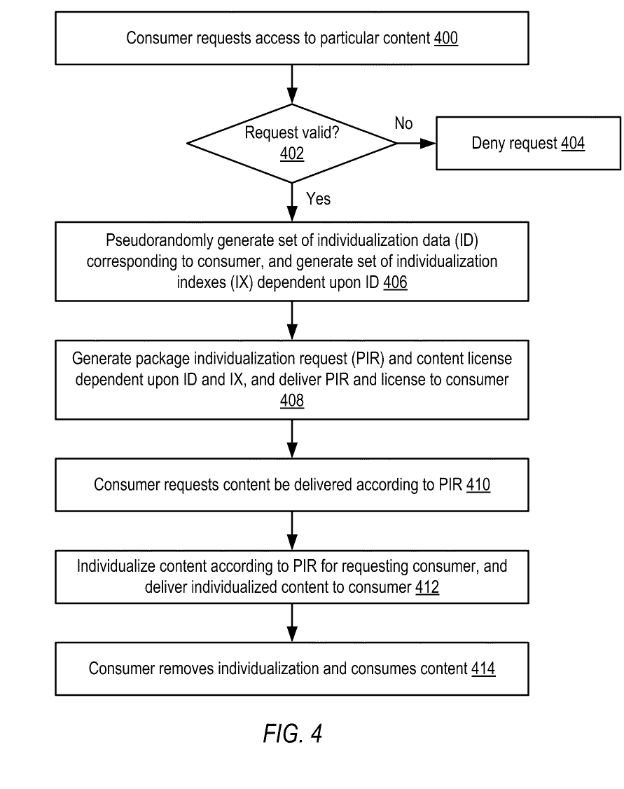

An example embodiment of a general method of operation of the systems of FIGS. 3A-C to deliver individualized content to a consumer is illustrated in FIG. 4. In the illustrated embodiment, operation begins in block 400 where a consumer requests access to a particular item of content. For example, a consumer may interact with runtime component 304 or with another component of CS 300 (e.g., a web browser) to request access to video or audio content, a document, or some other type of content. Correspondingly, in some embodiments, DRM component 302 may issue a license request to LS 320 in order to obtain the necessary credentials for displaying protected content (e.g., a license that includes a key for decrypting the protected content).

The consumer's request is then validated (block 402). For example, licensing component 322 may examine credentials provided by the consumer such as a password, key, certificate, etc., to determine whether the request should be granted. In various embodiments, validating the consumer's request may include authenticating that the requester is the entity it claims to be (e.g., that the request actually came from a particular CS 300, as opposed to a different client system masquerading as that system), and/or may include any other procedures suitable for determining whether a request for content should be granted, including communicating with other entities not shown in FIGS. 3A-C (e.g., third-party authentication servers).

If the consumer's request cannot be validated, it is denied (block 404). For example, licensing component 322 may communicate denial of the request to DRM component 302, which may in turn notify the consumer that the request for content was unsuccessful.

If the consumer's request is successfully validated, a set of individualization data (ID) corresponding to the consumer is pseudorandomly generated, and a set of individualization indexes (IX) is generated dependent upon the individualization data (block 406). Generally speaking, individualization data may denote a set of pseudorandom data generated specifically for the requesting consumer according to a suitable procedure. Individualization indexes may denote a set of offset values that, when applied to protected content 100, identify intervals within that content. Where the IX values are generated dependent upon the pseudorandom ID values, the resultant intervals of content may also be pseudorandomly defined.

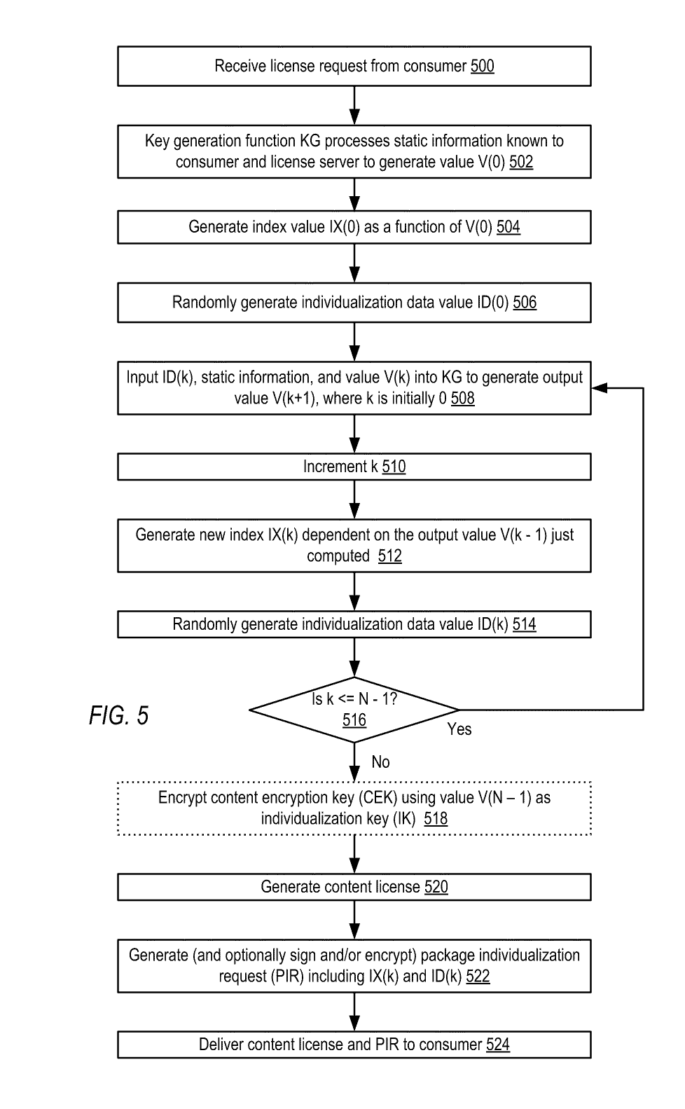

Based on the generated ID and IX values, a package individualization request (PIR) and a content license are generated and delivered to the consumer (block 408). For example, licensing component 322 may generate and deliver to DRM component 302 distinct records corresponding to the license and PIR. More details regarding various embodiments for generating ID, the PIR, and the content license are discussed below in conjunction with the description of FIG. 5.

The consumer then requests that the content be delivered according to the PIR (block 410). For example, DRM component 302 may be configured to communicate a request for content delivery to PS 330, and may include the PIR in this request. It is noted that in some embodiments, such as embodiments where licensing and packaging functionality is integrated (e.g., FIG. 3B), it may be unnecessary for the consumer to make a separate request for content delivery after having made a request to access content. For example, in some embodiments, licensing component 322 may be configured to convey the PIR directly to packaging component 332 without a separate request occurring from DRM component 302. Also, in some embodiments, content request information (such as a Uniform Resource Indicator (URI) identifying the requested content) may be embedded within the PIR itself at the time the PIR is generated, as opposed to being separately issued by the consumer. In some instances, this may enable the PIR to serve an authentication function, for example if the PIR is generated only after determining that the consumer is entitled to a license. Correspondingly, for these or other embodiments, block 410 may be omitted and its functionality implied by other elements of FIG. 4.

The requested content is then packaged according to the PIR, where the packaged content is individualized for the requesting consumer, and delivered to the consumer (block 412). For example, packaging component 332 may be configured to use the data in the PIR to transform protected content 100 into individualized protected content 102 using a reversible data transform operation that is less computationally expensive than the encryption operation used to generate protected content 100 from content 96. In some embodiments, to perform this transformation, packaging component 332 may employ the IX values to identify intervals within protected content 100. For each given one of these intervals, the portion of protected content 100 included within the interval may be combined with a respective one of the ID values according to the data transform operation to produce a corresponding portion of individualized protected content 102. As noted below, in some embodiments the data transform operation that is used may be selected from a number of such transforms, for example, according to a portion of the ID value.

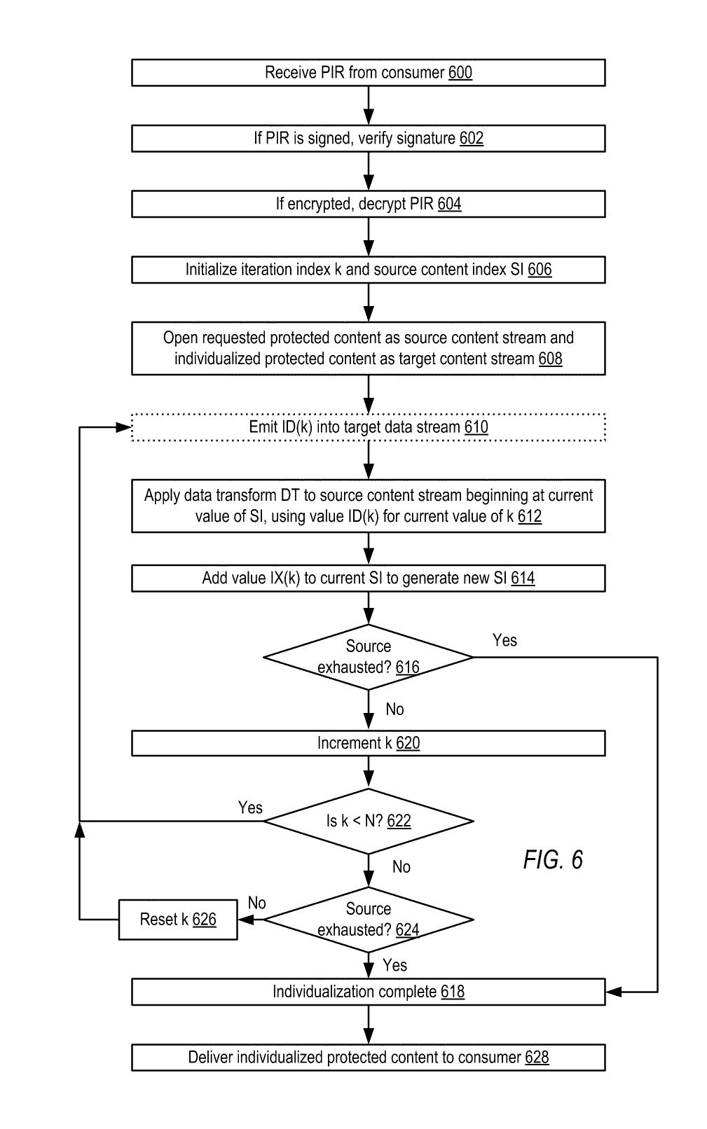

Because the PIR is generated on the basis of ID that is specific to the requesting consumer, different consumers requesting the same protected content 100 should receive different versions of individualized protected content 102 (i.e., instances of individualized protected content 102 that differ in content). This in turn may frustrate differential attempts to attack the protection of protected content 100 as discussed above with respect to FIG. 2, without incurring the computational expense of using a strong encryption algorithm to generate different encrypted versions of content 96 for different consumers. More details regarding various embodiments of performing content individualization are discussed below in conjunction with the description of FIG. 6.

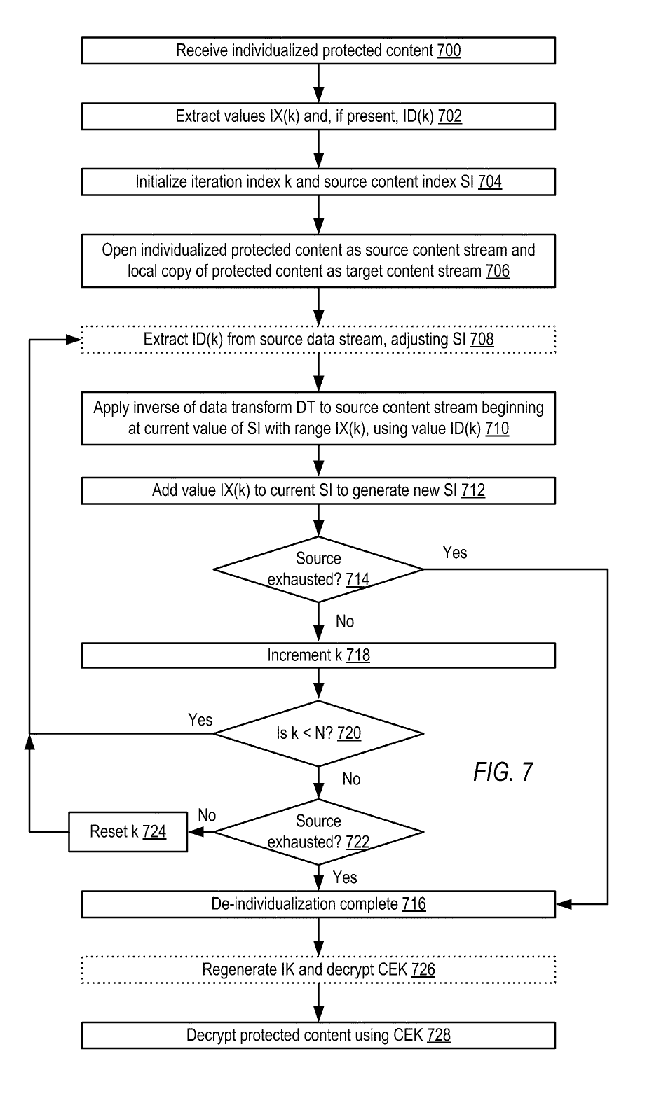

The consumer then removes the individualization from the delivered content and consumes the content (block 414). For example, DRM component 302 may be configured to utilize individualization information (which may be either embedded within or received separately from the delivered content) to perform the inverse of the process used to individualize the delivered individualized protected content 102. Following this “de-individualization” process, DRM component 302 may then decrypt protected content 100, and runtime component 304 may be configured to display the resulting content to the consumer. More details regarding embodiments of performing content de-individualization are discussed below in conjunction with the description of FIG. 7.

### License Generation for Content Individualization

FIG. 5 illustrates an example embodiment of a method of operation of license server 320 during a process of content individualization for a consumer. In some embodiments, licensing component 322 and/or other components executing on LS 320 may be configured to perform each of the actions shown in FIG. 5. Operation begins in block 500 where a request for a license is received from a consumer. For example, licensing component 322 may detect a license request generated by DRM component 302 on behalf of a consumer.

In the illustrated embodiment, after receiving a license request, licensing component 322 may be configured to perform N iterations to generate N distinct values of individualization data denoted ID(k), where k ranges from 0 to N−1. Licensing component 322 may further be configured to generate N distinct values of individualization index data denoted IX(k). N is a parameter that may vary in different embodiments. In some embodiments, N may vary dependent on the size of the protected content 100 to be individualized (e.g., N may increase as content size increases), while in other embodiments N may be invariant across differently-sized inputs. Increasing the value of N may result in increased security of the resultant individualized content owing to a greater degree of random obfuscation of the content, while decreasing the value of N may reduce the amount of computation time and resources needed to perform the individualization. One particular embodiment of the iteration is shown in FIG. 5, though variations are possible and contemplated.

At block 502, static information that is known both to the requesting consumer and to LS 320 is processed by a key generation function KG to produce an output value V(0). In various embodiments, this static information may be any type of information, and may include a username corresponding to the requesting consumer, a unique identifier of the content that has been requested, a public key, or any other type or combination of types of information. In various embodiments, the function KG may correspond to any of a variety of digest or hash-type functions such as, e.g., MD5 or a variant of the Secure Hash Algorithm such as SHA-1, SHA-256, etc. KG may also correspond to a key generation function employed by a symmetric encryption algorithm such as the Advanced Encryption Standard (AES) algorithm, for example.

An offset index value IX(0) is then generated as a function of the value V(0) (block 504). In some embodiments, the function employed may be a simple selection of particular bits or bytes from V to generate the corresponding value IX. For example, the least significant two bytes of V may be selected, although other amounts of data may be selected from other locations (e.g., the most significant bytes, or certain specified, discontiguous bits or bytes). In some embodiments, the function employed may involve the combination of different portions of V according to a Boolean or arithmetic function. It is noted that in some embodiments, IX(0) or any of the values IX(k) may be randomly generated in a manner that is not directly or indirectly dependent on an ID(k) value. For example, any of the values IX(k) may be generated as an independent random variable without using value V, or dependent upon some other function.

Also, individualization data value ID(0) is randomly generated (block 506). In various embodiments, any suitable random or pseudorandom number generator may be employed. In some embodiments, the size of each ID(k) may be chosen to be the same as the size of the output produced by key generation function KG (e.g., 128 bits, 256 bits, etc.). In some embodiments, values ID(k) may include a value that identifies which one of several data transform operations should be used in conjunction with the ID(k) value. For example, the data transform operations may be randomly selected or selected according to a defined order or procedure.

The value ID(k), the static information referred to above with respect to block 502, and the value V(k) are then input to the function KG to produce an output value V(k+1) (block 508). For example, these values may be concatenated or otherwise combined in a consistent order prior to application of the function KG.

The value of k is then incremented (block 510), a new offset index IX(k) is generated based on the output value V just computed (now V(k−1), following the increment of k) (block 512), and a new individualization value ID(k) is randomly generated (block 514). IX(k) and ID(k) may be generated in the same manner as IX(0) and ID(0) as discussed above. If k is less than or equal to N−1 (block 516), iteration continues from block 508.

Once iteration is complete, in some embodiments, the encryption key that is used to encrypt/decrypt protected content 100 (which may be referred to as the content encryption key CEK) may itself be encrypted using the value V(N−1) as a key (block 518). In such embodiments, the value V(N−1) may also be referred to as the individualization key IK. The encryption of CEK using IK is optional and may be omitted in some embodiments.

A content license may then be generated for delivery to the requesting consumer (block 520). In some embodiments, the generated license may include both the CEK (which may have been encrypted using IK) as well as the set of N individualization index values IX(k), where k ranges from 0 to N−1. In some embodiments, the license may optionally include the N individualization data values ID(k), as well as additional metadata.

A package individualization request (PIR) is also generated and encrypted (block 522). In some embodiments, the PIR may include both IX(k) and ID(k). Additionally, in some embodiments, the PIR may be encrypted only for use by the packaging server PS 330 (e.g., such that only PS 330 and not the requesting client may have the key needed to decrypt the PIR). In other embodiments, the PIR may be encrypted for use by both PS 330 and CS 300. Additionally, the PIR may be signed by the generating entity (e.g., LS 320), which may provide additional protection against an unauthorized client generating a bogus PIR. In some embodiments, the PIR may include additional metadata for use by PS 330. For example, such metadata may include a URI that identifies the content that is requested, an expiration date and/or time after which PS 330 may be configured to reject the PIR, or other suitable metadata.

The license and PIR are then delivered to the requesting consumer (block 524). For example, licensing component 322 may transmit the license and PIR to DRM component 302.

To summarize, according to the illustrated embodiment, LS 320 may be configured to generate a set of randomly generated individualization data values ID(k) as well as a set of individualization index values IX(k) that are determined dependent upon the randomly generated ID(k), certain static information, and the results of previous iterations. In some embodiments, the ID(k) values may be made directly available to the requesting consumer, for example by including them within the license generated for the consumer. In other embodiments, the consumer may only receive the IX(k) values, and the ID(k) values may be made available only to PS 330.

### Packaging Individualized Content for Delivery to Consumer

FIG. 6 illustrates an example embodiment of a method of operation of packaging/individualization server 330 during a process of content individualization for a consumer. In some embodiments, packaging component 332 and/or other components executing on PS 330 may be configured to perform each of the actions shown in FIG. 6. Operation begins in block 600 where a package individualization request (PIR) is received from a consumer. For example, packaging component 332 may detect a PIR that has been forwarded from a consumer along with a request for delivery of content. As noted above with respect to FIG. 3B, in some embodiments the functionality of licensing and packaging may be integrated into a single server environment. In some such embodiments, there may be no need for the consumer to forward the PIR, and this operation may be omitted.

If the PIR has been signed by the license server that generated it, the signature may be verified (block 602) and the PIR may be decrypted (block 604). However, in embodiments where the licensing and packaging components operate within the same secure, local environment, there may be no need for the PIR to be signed or encrypted. Instead, the ID(k) and IX(k) values may be passed directly from the licensing component(s) to the packaging component(s). In such embodiments, signature verification and PIR decryption may be omitted.

An iteration index k and a source content index SI each may be initialized to an initial value (block 606). Typically, the iteration index k should be initialized to the same initial value that was used during generation of ID(k) and IX(k), such as 0. SI may also be initialized to 0, or may be initialized to some other value known to the consumer. Additionally, the protected content 100 that the consumer has requested may be opened as a source content stream, and the individualized protected content 102 to be delivered to the consumer may be opened as a target content stream (block 608).

As noted above with respect to FIG. 5, in some embodiments, the individualization data values ID(k) may be directly presented to the consumer, e.g., as part of the license conveyed to the consumer. However, in other embodiments, the values ID(k) may be included only within the PIR, which may be encrypted such that the values ID(k) are not accessible to the consumer. In some such embodiments, the value ID(k) for the current value of k (e.g., 0, 1, etc.) may be emitted into the target content stream (block 610). Thus, for example, the values ID(k) may be embedded throughout the individualized protected content 102 that is delivered to the consumer. In embodiments where the values ID(k) are provided directly to the consumer, block 608 may be omitted.

A data transform DT is then applied to the block of the source content stream beginning at the current value of SI, using the value ID(k) for the current value of k (block 612). In some embodiments, transform DT may be applied to the range of bytes of the source content stream beginning at SI and defined by IX(k). Generally speaking, transform DT is a reversible data transform that combines source data with individualization data to produce individualized source data, such that the original source data may be recovered by applying the inverse of DT (e.g., by the consumer, as described below in conjunction with the description of FIG. 7). Specific characteristics of embodiments of transform DT are described following the description of FIG. 6. In general, however, transform DT may correspond to any reversible data transform that is at least on average less computationally expensive (e.g., requiring less time and/or fewer computing resources to compute) than the encryption used to generate protected content 100. Some examples of transform DT include Boolean operations such as exclusive-OR (XOR), logical operations such as a bitwise rotate operation, or arithmetic operations such as multiplication. In some embodiments, depending on the transform DT that is implemented, less than all of the value ID(k) may be employed during a given application of DT. Also, in some embodiments, for each iteration shown in FIG. 6, transform DT may be selected from a set of distinct transforms in any manner that is also known to the consumer. For example, packaging component 332 may proceed through the set of transforms in a predetermined order or a data-determined order, or according to a value that is specified in a given value ID(k).

The value IX(k) may then be added to source index SI to generate a new source index SI (block 614). If the source content stream has been exhausted, the individualization process may terminate (blocks 616-618). Otherwise, iteration index k may be incremented (block 620). If k is less than N (i.e., the total number of pieces of ID(k) and IX(k) included in the PIR) (block 622), operation may continue from block 610 in embodiments where the values of ID(k) are embedded within the target data stream. (In other embodiments where block 610 is omitted, operation may continue from block 612.)

If k is not less than N, then if the source content stream has not yet been exhausted (block 624), k may be reset to 0 (block 626) and operation may continue from block 610 in embodiments where ID(k) is embedded within the target data stream, or block 612 in other embodiments. Thus, in the illustrated embodiment, the values ID(k) and IX(k) are reused repeatedly until the source data stream has been exhausted. In some embodiments, the values ID(k) and IX(k) may be transformed in a manner known to the consumer before they are reused. For example, each time k is reset to 0, the values ID(k) and IX(k) could be reordered or otherwise modified in a data-independent or data-dependent fashion also known to the consumer.

If the source content stream has been exhausted, then the individualization process may terminate (block 616). The resultant target data stream may then be delivered to the consumer as individualized protected content 102 (block 628).

To summarize, in the embodiment of the individualization process shown in FIG. 6, the process operates to apply a data transform DT, using supplied individualization data ID(k), to portions of a source data stream (e.g., protected content 100) that are located at locations specified as a function of individualization index IX(k). In embodiments where the values IX(k) are generated in a manner at least partially dependent on random data, as discussed above with respect to FIG. 5, both the specific locations within protected content 100 that are modified and the manner in which the locations are modified may vary when the individualization process is applied on different occasions to the same protected content 100. Thus, the process of FIG. 6 may yield different versions of individualized protected content 102 for the same input protected content 100, which may help thwart the differential attacks discussed above with respect to FIG. 2.

As noted above, the data transform DT is selected such that it is at least on average less computationally expensive than the encryption used to encrypt protected content 100. Generally speaking, a transform DT may be considered less computationally expensive than a given encryption algorithm E if, given identical computing resources and an identical block of input data, on average, transform DT requires less time to compute its result for the input data than encryption algorithm E. (It is noted that for some individual patterns of input data, it may be possible for a particular encryption algorithm E to complete more quickly than a particular transform DT. However, even in such cases, particular transform DT may still complete more quickly than particular encryption algorithm E for the vast majority of possible or probable inputs, and thus particular transform DT would still be considered less computationally expensive on average than particular encryption algorithm E.) Other techniques for assessing computational expense, such as the theoretical computational complexity (e.g., in time and/or space) of an algorithm may also be employed.

Thus, for example, embodiments of transforms DT that consist of a single, reversible, two-input arithmetic operation (e.g., add, subtract, multiply, divide), Boolean operation (e.g., XOR) or shift operation (e.g., bitwise rotate, bitwise permute) may be on average less computationally expensive than any encryption algorithm that employs more than one such operation. In some embodiments, the performance difference between transform DT and encryption algorithm E for the same input data block may be a decimal or binary order of magnitude, or greater.

In some embodiments, transform DT may be considered to be less computationally expensive than encryption algorithm E where to generate the output for a given input data block B, the encryption algorithm E iterates multiple times over the same block B, whereas the result of transform DT is produced upon a single application of DT without iteration. For example, to generate an encrypted output block for a given input block, most block ciphers (e.g., DES, 3DES, AES, Feistel ciphers, Rijndael ciphers, etc.) perform multiple iterations or “rounds” on the input block. By contrast, even in embodiments where transform DT performs a sequence of operations on an input data block (e.g., a bitwise rotate followed by an XOR of the rotate result, or some other suitable sequence), the sequence may only be performed once per input data block, rather than multiple times as with block ciphers.

In some embodiments, the number of processor-executable instructions needed to implement transform DT and encryption algorithm E may serve as an indication of the computational expense or complexity of these procedures. For example, in an embodiment where transform DT is implemented as a simple XOR operation between the source data block and individualization data, transform DT may map directly to a single type of processor-executable instruction, such as an XOR instruction. Depending on the input size of transform DT, multiple instructions may be needed (e.g., 8 64-bit XOR instructions for a 512-bit transform DT). By contrast, a block cipher or other type of encryption algorithm E may require hundreds or thousands of instructions to transform a source data block to its encrypted form.

### Consumer Processing of Individualized Content

FIG. 7 illustrates an example embodiment of a method of operation of client system 300 to process individualized protected content 102 generated according to the techniques described above, or a suitable variant of those techniques. In some embodiments, DRM component 302 and/or other components executing on CS 300 may be configured to perform each of the actions shown in FIG. 7. Operation begins in block 700 where a consumer receives protected content that has been individualized for the consumer. For example, DRM component 302 may receive individualized protected content 102 from PS 330 after PS 330 performs the individualization process discussed above with respect to FIG. 6.

The individualization index values IX(k) and, if they are present, the individualization data values ID(k) are extracted (block 702). For example, as noted above, in some embodiments IX(k) may be included in the license issued by LS 320. In various embodiments, ID(k) may either be included within the license or embedded within individualized protected content 102.

The individualization process previously applied to generate individualized protected content 104 may then be inverted to obtain protected content 102, a process that may also be referred to as “de-individualization.” Preliminarily, an iteration index k and a source content index SI each may be initialized to an initial value (block 704). For example, k and SI may be initialized to the same initial values used during the individualization process. Additionally, the individualized protected content 104 that the consumer has received may be opened as a source content stream, and a local copy of protected content 102 may be opened as a target content stream (block 706).

In embodiments where the values ID(k) were embedded within individualized protected content 104 during the individualization process, the value ID(k) for the current value of k may be extracted from the source content stream at the location SI, adjusting SI by the size of the content extracted (block 708). For example, each value ID(k) may include a known number of bytes that may be invariant or may vary in a predictable way known to the consumer. This number of bytes may be extracted from the source content stream, and may also be added to SI to adjust the index accordingly. In embodiments where ID(k) is not embedded within individualized protected content 104 but is instead delivered to the consumer in a different fashion (e.g., within the license received from a license server), block 708 may be omitted.

Using the current value of ID(k), the inverse of transform DT is then applied to the range of the source content stream beginning at SI and having an extent of IX(k) (block 710). This process may be similar to block 612 of FIG. 6, except that the effect of transform DT is being reversed.

The value IX(k) may then be added to source index SI to generate a new source index (block 712). If the source content stream has been exhausted, the de-individualization process may terminate (blocks 714-716). Otherwise, iteration index k may be incremented (block 718). If k is less than N (i.e., the total number of pieces of ID(k) and IX(k) used during individualization) (block 720), operation may continue from block 708 in embodiments where the values of ID(k) are embedded within the source data stream. (In other embodiments where block 708 is omitted, operation may continue from block 710.)

If k is not less than N, then if the source content stream has not yet been exhausted (block 722), k may be reset to 0 (block 724) and operation may continue from block 708 in embodiments where ID(k) is embedded within the source data stream, or block 710 in other embodiments. Thus, in the illustrated embodiment, the values ID(k) and IX(k) are reused repeatedly until the source data stream has been exhausted. In some embodiments, the values ID(k) and IX(k) may be transformed by the consumer in a manner consistent with their transformation during the individualization process. For example, each time k is reset to 0, the values ID(k) and IX(k) could be reordered or otherwise modified in a data-independent or data-dependent fashion also employed by the packaging server performing the individualization. If the source content stream has been exhausted, then the de-individualization process may terminate (block 716).

The resultant target data stream may then correspond to protected content 102. However, protected content 102 may still require decryption before it can be used by the consumer. As noted above with respect to FIG. 5, in some embodiments, the content encryption key CEK may itself be encrypted with an individualization key IK generated during the individualization process. In such embodiments, the IK may be regenerated as described in greater detail below, and the CEK may be decrypted using the regenerated IK (block 726). In embodiments where the CEK is not encrypted, block 726 may be omitted.

Protected content 102 is then decrypted according to the CEK to generate the original content 96 (block 728). The resultant content may then be displayed to a user, e.g., by runtime component 304, or otherwise processed.

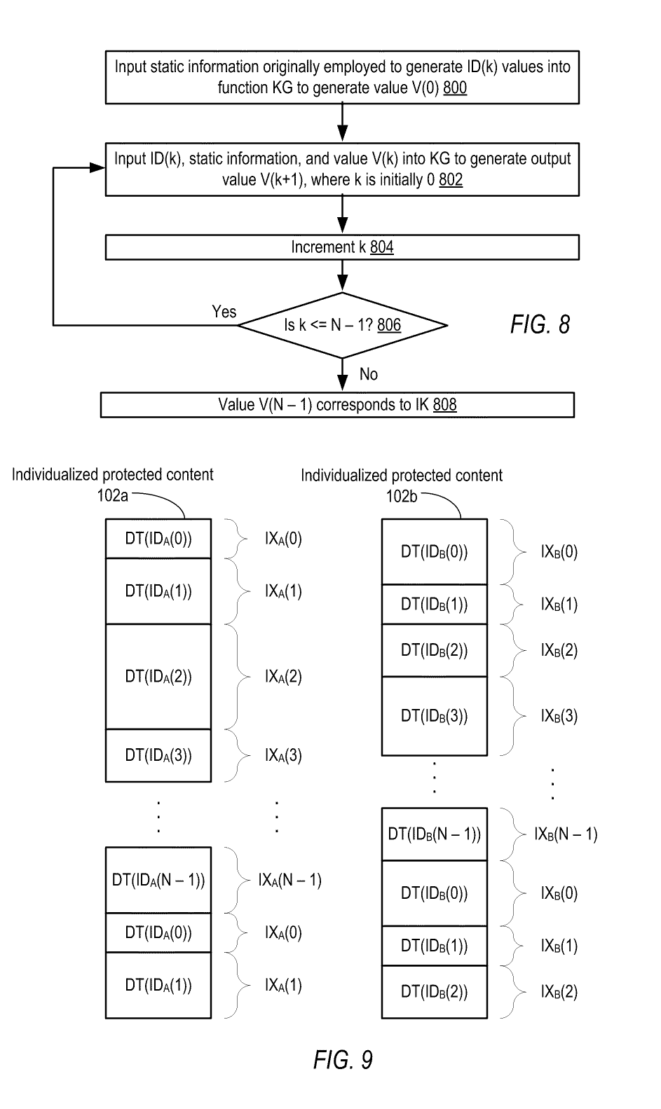

FIG. 8 illustrates a process by which the IK may be regenerated as discussed above with respect to block 726 of FIG. 7. In the illustrated embodiment, operation begins in block 800 where the static information originally employed to generate the ID(k) values is input to the key generation function KG also previously used, to generate an output value V(0) (e.g., in a manner similar to that discussed above with respect to FIG. 5).

With the value k initially being set to zero, the value ID(k), the static information referred to above with respect to block 800, and the value V(k) are then input to the function KG to produce an output value V(k+1) (block 802). For example, these values may be concatenated or otherwise combined in the same order as they were during the original generation of the values ID(k).

The value of k is then incremented (block 804), and if k is less than or equal to N−1 (block 806), iteration continues from block 802. Once N iterations have been completed, the value V(N−1) may correspond to the individualization key IK (block 808). It is noted that in embodiments where the values ID(k) are embedded within individualized protected content 102 rather than being separately provided to the consumer, it may be necessary for the consumer to receive most or all of individualized protected content 102 (i.e., sufficient to obtain all of the values ID(k)) before the IK may be regenerated.

FIG. 9 graphically illustrates differences between two versions of individualized protected content 102a-b that may be generated from the same input protected content 100 for requests by two different consumers, according to embodiments of the techniques described above. In the illustrated embodiment, each instance of individualized protected content 102a-b is shown as divided into a number of regions. The boundaries between the regions of individualized protected content 102a-b are shown as having extents corresponding to the individualization index values IX_{A}(k) and IX_{B}(k), respectively. Moreover, the data contained within each of the regions is shown as having been modified, via data transform DT, as a function of the individualization data values ID_{A}(k) and ID_{B}(k), respectively. (As described above, the N distinct elements of IX(k) and ID(k) may be reused an arbitrary number of times during content individualization, depending on the length of the input content.)

As is evident from FIG. 9, the two versions of individualized protected content 102a-b may differ from one another in at least two distinct ways. Because the values ID(k) may be generated at random each time protected content 100 is individualized, it is unlikely that two different values of ID(k) would generate the same result when applied to the same portion of protected content 100, even for relatively simple embodiments of transform DT. However, because the values IX(k) are also randomly generated (e.g., they may be partially dependent upon the randomly-generated ID(k)), and because the values IX(k) may determine the boundaries between regions where different values ID(k) are employed, it is likely that few or none of the boundaries will overlap between any two versions of individualized protected content 102. That is, each time content individualization occurs, the original protected content 100 may be divided into differently-sized regions having different, randomly determined boundaries. Within each of these regions, the original data may be transformed according to a different set of randomly generated values ID(k).

As a result, the degree of identifiable correlation between individualized protected content 102a-b may be significantly reduced, even though both versions may derive from the same content source. (For example, the data block shown in FIG. 9 as DT(ID_{A}(0)) may include the hexadecimal data 0x1938FC9A28DC, whereas the data block shown as DT(ID_{B}(0)) may include the hexadecimal data 0xF08192AB439C458FBB29524271, which is quite different in both content and length.) This may in turn decrease the vulnerability of encrypted content to differential attacks of the sort discussed above with respect to FIG. 2. Moreover, the individualization may be accomplished via the use of a transform DT that is potentially significantly less computationally expensive than fully re-encrypting protected content 100 for different consumers would be.

### Example Computer System

Various embodiments of a system and method for individualizing content for a consumer, as described herein, may be executed on one or more computer systems, which may interact with various other devices. One such computer system is computer system 1000 illustrated by FIG. 10, which may in various embodiments implement any of the elements illustrated in FIGS. 1-8. For example, computer system 1000 may be configured to implement any of DRM component 302, runtime component 304, licensing component 322, packaging component 332, or any other component configured to implement the techniques described above. Any of these components may be stored in memory as processor-executable program instructions 1022. In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. In some embodiments, it is contemplated that embodiments may be implemented using a single instance of computer system 1000, while in other embodiments multiple such systems, or multiple nodes making up computer system 1000, may be configured to host different portions or instances of various embodiments. For example, in some embodiments, some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments processors 1010 may be general-purpose or embedded processors implementing any of a variety of instruction set architectures (ISAs), such as the x86, PowerPC™, SPARC™, or MIPS™ ISAs, or any other suitable ISA. In multiprocessor systems, each of processors 1010 may commonly, but not necessarily, implement the same ISA.

System memory 1020 may be configured to store program instructions 1022 and/or data 1032 accessible by processor 1010. In various embodiments, data 1032 may include protected or unprotected content as described above (e.g., protected content 100) as well as other data, such as copies of content licenses or client-specific credentials, for example. In various embodiments, program instructions 1022 may be executable by the processor(s) to implement any of the various components described herein. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the DRM framework (as described above), may be stored within system memory 1020. In other embodiments, program instructions and/or data may be received, sent or stored upon different types of computer-accessible media or on similar media separate from system memory 1020 or computer system 1000.

In some embodiments, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. Also, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network (e.g., network 500), such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or accessing data by one or more computer systems 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

In some embodiments, the illustrated computer system may implement any of the methods described above, such as the methods illustrated by FIGS. 4-8. In other embodiments, different elements and data may be included.

Those skilled in the art will appreciate that computer system 1000 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the embodiments described herein may be practiced with other computer system configurations.

Various embodiments may further include storing instructions and/or data implemented in accordance with the foregoing description upon a computer-accessible medium. Generally speaking, a computer-accessible medium may include a storage medium or memory medium such as magnetic or optical media, e.g., disk or DVD/CD-ROM, volatile or non-volatile media such as RAM (e.g. SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. Various modifications and changes may be made as would be obvious to a person skilled in the art having the benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A system comprising:
one or more processors; and
memory coupled to the one or more processors, the memory comprising instructions for a packaging component executable to:
receive a request to package protected content for a consumer according to a plurality of pseudorandomly-generated individualization data values ID(k) and a plurality of pseudorandomly-generated individualization indexes IX(k), the protected content encrypted according to an encryption algorithm; and
generate individualized protected content that has been individualized for the consumer, such that when different instances of individualized protected content are generated from a same version of the protected content for different consumers, the different instances differ in content;
the instructions to generate individualized protected content are further executable to:
identify pseudorandom intervals within the protected content using the individualization indexes, and for each one of the intervals; and
combine the protected content included within the interval with a respective one of the individualization values according to a reversible data transform operation selected from a plurality of distinct data transform operations in a manner that is known to the consumer, the data transform operation being less computationally expensive than the encryption algorithm.

2. The system as recited in claim 1, wherein for any block of input data, to produce an encrypted output from the input block of data, the encryption algorithm is configured to perform multiple iterations on the input block of data, and wherein to produce a transformed output from the input block of data, the data transform operation is configured to perform only one iteration on the input block of data.

3. The system as recited in claim 2, wherein the encryption algorithm comprises a block cipher algorithm, and wherein the data transform operation comprises an arithmetic operation, a Boolean operation, or a shift operation.

4. The system as recited in claim 1, wherein to generate the individualized protected content, the packaging component is further configured to embed the individualization data values within the individualized protected content prior to delivering the individualized protected content to the consumer.

5. (canceled)

6. The system as recited in claim 1, wherein the individualization data values ID(k) comprise N values denoted ID(0) through ID(N−1), the individualization index values IX(k) comprising N values denoted IX(0) through IX(N−1), and wherein the memory further comprises instructions for a licensing component executable to:
pseudorandomly generate ID(0) and IX(0);
generate a value V(0) according to a key generation function; and for each value of k ranging sequentially from 0 to N−2:
input ID(k) and V(k) into the key generation function to produce value V(k+1); and
pseudorandomly generate ID(k+1) and IX(k+1).

7. The system as recited in claim 6, wherein each of IX(0) through IX(N−1) is generated dependent upon a respective one of V(0) through V(N−1).

8. The system as recited in claim 7, wherein generation of each of IX(0) through IX(N−1) is further dependent upon static information known to both the consumer and the licensing component.

9. The system as recited in claim 6, wherein the protected content is encrypted according to a content encryption key (CEK), and wherein the licensing component is further configured to encrypt the CEK according to an individualization key (IK) prior to conveying the encrypted CEK to the consumer, the IK corresponding to V(N−1).

10. The system as recited in claim 6, wherein the instructions executable to implement the licensing component are stored in a memory distinct from the memory that stores the instructions executable to implement the packaging component, and wherein the instructions executable to implement the licensing component are executable by one or more processors that are distinct from the one or more processors configured to execute the instructions executable to implement the packaging component.

11. A computer-implemented method comprising:
one or more computer systems executing instructions to implement:
receiving, at a packaging component, a request to package protected content for a consumer according to a plurality of pseudorandomly generated individualization data values ID(k) and a plurality of pseudorandomly-generated individualization indexes IX(k), the protected content encrypted according to an encryption algorithm;
generating, at the packaging component, individualized protected content that has been individualized for the consumer, such that when different instances of individualized protected content are generated from a same version of the protected content for different consumers, the different instances differ in content; and
the generating further comprising:
identifying pseudorandom intervals within the protected content using the individualization indexes; and
combining, for each one of the intervals, the protected content included within the interval with a respective one of the individualization values according to a reversible data transform operation selected from a plurality of distinct data transform operations in a manner that is known to the consumer, wherein the data transform operation being less computationally expensive than the encryption algorithm.

12. The computer-implemented method as recited in claim 11, wherein for any block of input data, to produce an encrypted output from the input block of data, the encryption algorithm performs multiple iterations on the input block of data, and wherein to produce a transformed output from the input block of data, the data transform operation performs only one iteration on the input block of data.

13. The computer-implemented method as recited in claim 12, wherein the encryption algorithm comprises a block cipher algorithm, and wherein the data transform operation comprises an arithmetic operation, a Boolean operation, or a shift operation.

14. The computer-implemented method as recited in claim 11, wherein the generating comprises embedding the individualization data values within the individualized protected content prior to delivering the individualized protected content to the consumer.

15. (canceled)

16. The computer-implemented method as recited in claim 11, wherein the individualization data values ID(k) comprise N values denoted ID(0) through ID(N−1), wherein the individualization index values IX(k) comprise N values denoted IX(0) through IX(N−1), and wherein the method further comprises the one or more computer systems executing instructions to implement:
generating pseudorandomly, at a licensing component, ID(0) and IX(0);
at the licensing component, a value V(0) according to a key generation function; and
for each value of k ranging sequentially from 0 to N−2, the licensing component:
inputting ID(k) and V(k) into the key generation function to produce value V(k+1); and
generating pseudorandomly ID(k+1) and IX(k+1).

17. The computer-implemented method as recited in claim 16, wherein generating pseudorandomly each of IX(0) through IX(N−1) occurs dependent upon a respective one of V(0) through V(N−1).

18. The computer-implemented method as recited in claim 17, wherein generating each of IX(0) through IX(N−1) is further dependent upon static information known to both the consumer and the licensing component.

19. The computer-implemented method as recited in claim 16, wherein the protected content is encrypted according to a content encryption key (CEK), and wherein the method further comprises the licensing component encrypting the CEK according to an individualization key (IK) prior to conveying the encrypted CEK to the consumer, wherein the IK corresponds to V(N−1).

20. The computer-implemented method as recited in claim 16, wherein one or more computer systems executing instructions to implement the packaging component are distinct from one or more computer systems executing instructions to implement the licensing component.

21. One or more computer-readable storage memories having stored thereon multiple instructions for a packaging component, that when executed by one or more processors, cause the one or more processors to:
receive a request to package protected content for a consumer according to a plurality of pseudorandomly-generated individualization data values ID(k) and a plurality of pseudorandomly-generated individualization indexes IX(k), the protected content encrypted according to an encryption algorithm;
generate individualized protected content that has been individualized for the consumer, such that when different instances of individualized protected content are generated from a same version of the protected content for different consumers, the different instances differ in content; and
to generate the individualized protected content comprises:
identify pseudorandom intervals within the protected content using the individualization indexes; and
combine, for each given one of the intervals, the protected content included within the interval with a respective one of the individualization values according to a reversible data transform operation selected from a plurality of distinct data transform operations in a manner that is known to the consumer, the data transform operation being less computationally expensive than the given encryption algorithm.

22. A system comprising:
one or more processors; and
memory coupled to the one or more processors, the memory comprising instructions for a digital rights management (DRM) component, that corresponds to a consumer, executable to:
receive protected content that has been individualized for the consumer according to a plurality of pseudorandomly-generated individualization data values ID(k) and a plurality of pseudorandomly-generated individualization indexes IX(k), the protected content encrypted according to an encryption algorithm, and the individualized protected content being individualized for the consumer such that when different instances of individualized protected content are generated from a same version of the protected content for different consumers, the different instances differ in content;
recover the protected content from the individualized protected content; and
the instructions to recover the protected content are further executable to:
identify pseudorandom intervals within the protected content using the individualization indexes, and
combine, for each one of the intervals, the individualized protected content included within the interval with a respective one of the individualization values according to an inverse of a reversible data transform operation used to generate the individualized protected content selected from a plurality of distinct data transform operations in a manner that is known to the consumer, the data transform operation and its inverse being less computationally expensive than the given encryption algorithm.

23. The system as recited in claim 22, wherein for any block of input data, to produce an encrypted output from the input block of data, the encryption algorithm is configured to perform multiple iterations on the input block of data, and wherein to produce a transformed output from the input block of data, the inverse of the data transform operation is configured to perform only one iteration on the input block of data.

24. The system as recited in claim 23, wherein the encryption algorithm comprises a block cipher algorithm, and wherein the data transform operation comprises an arithmetic operation, a Boolean operation, or a shift operation.

25. The system as recited in claim 22, wherein to recover the protected content from the individualized protected content, the DRM component is further configured to extract the individualization data values from within the individualized protected content.

26. The system as recited in claim 22, wherein the protected content is encrypted according to a content encryption key (CEK), wherein the CEK has been encrypted according to an individualization key (IK) prior to the encrypted CEK being received by the consumer, and wherein the DRM component is further configured to regenerate the IK from the individualization data values ID(k).

27. The system as recited in claim 26, wherein the individualization data values ID(k) comprise N values denoted ID(0) through ID(N−1), and wherein to regenerate the IK, the instructions for the DRM component are further executable to:
generate a value V(0) dependent on a key generation function;
for each value of k ranging sequentially from 0 to N−1, input ID(k) and V(k) into the key generation function to produce value V(k+1); and
output value V(N−1) as the IK.

28. The system as recited in claim 22, wherein the individualization indexes IX(k) are generated dependent upon the individualization data values ID(k).

29. A computer-implemented method comprising:
one or more computer systems executing instructions to implement:
receiving, at a digital rights management (DRM) component, protected content that has been individualized for a consumer according to a plurality of pseudorandomly-generated individualization data values ID(k) and a plurality of pseudorandomly-generated individualization indexes IX(k), the protected content encrypted according to an encryption algorithm, and the individualized protected content being individualized for the consumer such that when different instances of individualized protected content are generated from a same version of the protected content for different consumers, the different instances differ in content;
recovering, at the DRM component, the protected content from the individualized protected content; and
the recovering comprising:
identifying pseudorandom intervals within the protected content using the individualization indexes; and
combining, for each one of the intervals, the individualized protected content included within the interval with a respective one of the individualization values according to an inverse of a reversible data transform operation used to generate the individualized protected content selected from a plurality of distinct data transform operations in a manner that is known to the consumer, the data transform operation and its inverse being less computationally expensive than the encryption algorithm.

30. The computer-implemented method as recited in claim 29, wherein for any block of input data, to produce an encrypted output from the input block of data, the encryption algorithm is configured to perform multiple iterations on the input block of data, and wherein to produce a transformed output from the input block of data, the inverse of the data transform operation is configured to perform only one iteration on the input block of data.

31. The computer-implemented method as recited in claim 30, wherein the encryption algorithm comprises a block cipher algorithm, and wherein the data transform operation comprises an arithmetic operation, a Boolean operation, or a shift operation.

32. The computer-implemented method as recited in claim 29, wherein the recovering comprises extracting the individualization data values from within the individualized protected content.

33. The computer-implemented method as recited in claim 29, wherein the protected content is encrypted according to a content encryption key (CEK), wherein the CEK has been encrypted according to an individualization key (IK) prior to the encrypted CEK being received by the consumer, and wherein the method further comprises regenerating, at the DRM component, the IK from the individualization data values ID(k).

34. The computer-implemented method as recited in claim 33, wherein the individualization data values ID(k) comprise N values denoted ID(0) through ID(N−1), and wherein regenerating the IK comprises:
generating a value V(0) dependent on a key generation function;
inputting for each value of k ranging sequentially from 0 to N−1, the DRM component inputting ID(k) and V(k) into the key generation function to produce value V(k+1); and
outputting value V(N−1) as the IK.

35. The computer-implemented method as recited in claim 29, wherein the individualization indexes IX(k) are generated dependent upon the individualization data values ID(k).

36. One or more computer-readable storage memories having stored thereon multiple instructions for a digital rights management (DRM) component, that corresponds to a consumer, that when executed by one or more processors, cause the one or more processors to:
receive protected content that has been individualized for the consumer according to a plurality of pseudorandomly-generated individualization data values ID(k) and a plurality of pseudorandomly-generated individualization indexes IX(k), the protected content is encrypted according to an encryption algorithm, and the individualized protected content being-individualized for the consumer such that when different instances of individualized protected content are generated from a same version of the protected content for different consumers, the different instances differ in content; and
recover the protected content from the individualized protected content;
the instructions to recover the protected content are further executable to:
identify pseudorandom intervals within the protected content using the individualization indexes: and
combine, for each one of the intervals, the individualized protected content included within the interval with a respective one of the individualization values according to an inverse of a reversible data transform operation used to generate the individualized protected content selected from a plurality of distinct data transform operations in a manner that is known to the consumer, wherein the data transform operation and its inverse being less computationally expensive than the encryption algorithm.
